(19) United States
(12) Patent Application Publication
(10) Pub. No.: US 2015/0097554 A1
(43) Pub. Date: Apr. 9, 2015

(54) Method and Apparatus for Measuring Location of User Terminal Using Magnetic Field

(71) Applicant: IDECCA INC., Seoul (KR)

(72) Inventor: Chan Jong Park, Seoul (KR)

(73) Assignee: IDECCA INC., Seoul (KR)

(21) Appl. No.: 14/153,988

(22) Filed: Jan. 13, 2014

(30) Foreign Application Priority Data
Oct. 4, 2013 (KR) 10-2013-0118758

(51) Int. Cl. G01B 7/004

(52) U.S. Cl. CPC G01B 7/004
USPC 324/207.14

(57) ABSTRACT

A method for measuring a location of a user terminal, using a magnetic field includes receiving information on a map of the magnetic field; acquiring a first measured value from a magnetic field sensor provided in the user terminal; acquiring a second measured value from another sensor provided in the user terminal and distinguished from the magnetic field sensor; and measuring a location of the user terminal based on the information on the map of the magnetic field, the first measured value and the second measured value.

### CROSS REFERENCE TO RELATED APPLICATION

This application claims priority from and the benefit of Korean Patent Application No. 10-2013-0118758, filed on Oct. 4, 2013, which is hereby incorporated by reference for all purposes as if fully set forth herein.

### BACKGROUND OF THE DISCLOSURE

1. Field of the Disclosure

Exemplary embodiments of the disclosure relate to a system for measuring a location of a user terminal, using a magnetic field, more particularly, to a technology for measuring a location of a user terminal, using a magnetic field sensor provided in a user terminal and magnetic field map information.

2. Discussion of the Background

Generally, technology for measuring a location of a user terminal measures a location of a user terminal inside or outside a building. In such technology, an acceleration sensor, an inertia sensor, a gyro sensor, a pressure sensor, an ultrasonic sensor, a temperature-humidity sensor, an infrared sensor, a UWB (Ultra-Wideband) sensor, Wi-Fi (Wireless Fidelity) sensor or a LED (Light Emitting Diode) sensor may be used so as to measure a location of a user terminal indoor and outdoor.

However, the technology using an acceleration sensor, an inertia sensor, a gyro sensor, a pressure sensor, an ultrasonic sensor, a temperature-humidity sensor, an infrared sensor, a UWB (Ultra-Wideband) sensor, Wi-Fi (Wireless Fidelity) sensor or a LED (Light Emitting Diode) sensor has a disadvantage of deteriorated accuracy in measuring a vertical location of a user terminal.

Accordingly, there are increasing demands for a method and a system capable of measuring a location of the user terminal accurately.

### SUMMARY OF THE DISCLOSURE

Exemplary embodiments of the present disclosure provide a method, an apparatus and a system for measuring a location of a user terminal, using a magnetic field sensor provided in a user terminal and information on a map of a magnetic field.

Exemplary embodiments of the present disclosure also provide a method, an apparatus and a system which may use a different sensor distinguished from the magnetic field sensor, while measuring the location of the user terminal using the magnetic field sensor and the information on the map of the magnetic field.

Exemplary embodiments of the present disclosure also provide a method, an apparatus and a system for compensating a location of a user terminal, using PDR (Pedestrian Dead-Reckoning information acquired from a different sensor distinguished from the magnetic field sensor.

Exemplary embodiments of the present disclosure also provide a method, an apparatus and a system for providing specific services associated with a location of a user's terminal based on a map of a magnetic field.

Additional features of the present disclosure will be set forth in the description which follows, and in part will be apparent from the description, or may be learned by practice of the disclosed subject matter.

Exemplary embodiments of the present disclosure disclose a method for measuring a location of a user terminal, using a magnetic field comprising receiving information on a map of the magnetic field; acquiring a first measured value from a magnetic field sensor provided in the user terminal; acquiring a second measured value from another sensor provided in the user terminal and distinguished from the magnetic field sensor; and measuring a location of the user terminal based on the information on the map of the magnetic field, the first measured value and the second measured value.

The sensor distinguished from the magnetic field sensor may include one or more of an acceleration sensor, an inertia sensor, a gyro sensor, a pressure sensor, an ultrasonic sensor, a temperature-humidity sensor, an infrared sensor, a UWB (Ultra-Wideband) sensor, Wi-Fi (Wireless Fidelity) sensor or a LED (Light Emitting Diode) sensor.

The information on the map of the magnetic field sensor may be set based on horizontal components and vertical components of a magnetic field which are collected corresponding to preset coordinate information from one or more of the user terminal and a magnetic field measuring robot provided in the user terminal.

The measuring the location of the user terminal may include measuring a horizontal location and a vertical location of the user terminal based on the result of the matching a horizontal value and a vertical value provided in the first measured value with a horizontal component and a vertical component provided in the information on the map of the magnetic field, respectively; and correcting a horizontal location and a vertical location, using the second measured value.

The measuring the location of the user terminal may include acquiring one or more of a terminal user's stride, a moving direction of the user terminal, a moving distance of the user terminal and a moving speed of the user terminal based on the second measured value; and correcting the horizontal location and the vertical location, using one or more of the user's stride, the moving direction of the user terminal, the moving distance of the user terminal and the moving speed of the user terminal.

The measuring the location of the user terminal may further include receiving an initial location of the user terminal from the user terminal; setting candidate locations of the user terminal based on the provided initial locations; and selecting a location of the user terminal from the candidate locations based on the information on the map of the magnetic field, the first measured value and the second measured value.

The method of measuring the location of the user terminal, using the magnetic field, may further include providing a specific service associated with the location of the user terminal based on the location of the user terminal.

Another aspect, exemplary embodiments disclosure an apparatus for measuring a location of a user terminal, using a magnetic field, including a receiving unit for receiving information on a map of a magnetic field; a first measured value acquiring unit for acquiring a first measured value from a magnetic field sensor provided in the user terminal; a second measured value acquiring unit for acquiring a second measured value from another senor provided in the user terminal and distinguished from the magnetic sensor; and a location measuring unit for measuring the location of the user terminal based on the information on the map of the magnetic field, the first measured value and the second measured value.

The location measuring unit may match a horizontal value and a vertical value provided in the first measured value with a horizontal component and a vertical component provided in the information on the map of the magnetic field, respectively, and may measure a horizontal location and a vertical location of the user terminal based on the result of the matching. The location measuring unit may correct the horizontal location and the vertical location of the user terminal, using the second measured value.

According to the exemplary embodiments of the disclosure, exemplary embodiments of the present disclosure provide a method, an apparatus and a system for measuring a location of a user terminal, using a magnetic field sensor provided in a user terminal and information on a map of a magnetic field.

Exemplary embodiments of the present disclosure also provide a method, an apparatus and a system which may use a different sensor distinguished from the magnetic field sensor, while measuring the location of the user terminal using the magnetic field sensor and the information on the map of the magnetic field.

Exemplary embodiments of the present disclosure also provide a method, an apparatus and a system for compensating a location of a user terminal, using PDR (Pedestrian Dead-Reckoning information acquired from a different sensor distinguished from the magnetic field sensor.

Exemplary embodiments of the present disclosure also provide a method, an apparatus and a system for providing specific services associated with a location of a user's terminal based on a map of a magnetic field.

It is to be understood that both the foregoing general description and the following detailed description are exemplary and explanatory and are intended to provide further explanation of the disclosed subject matter as claimed.

### BRIEF DESCRIPTION OF THE DRAWINGS

The accompanying drawings, which are included to provide a further understanding of the disclosed subject matter and are incorporated in and constitute a part of this specification, illustrate exemplary embodiments of the disclosed subject matter, and together with the description serve to explain the principles of the disclosed subject matter.

FIG. 1 is a diagram illustrating a map of a magnetic field according to exemplary embodiments of the disclosure;

FIG. 2 is a diagram illustrating a map of a magnetic field based on a height;

FIG. 3 is a diagram illustrating a process of measuring a location of a user terminal according to exemplary embodiments of the disclosure;

FIG. 4 is a diagram illustrating a specific service associated with a location of a user terminal according to exemplary embodiments of the disclosure;

FIG. 5 is a flow chart illustrating a method of measuring a location of a user terminal, using a magnetic field, according to exemplary embodiments of the disclosure;

FIG. 6 is a first flow chart specifically illustrating a process 540 of measuring the location of the user terminal shown in FIG. 5;

FIG. 7 is a second flow chart specifically illustrating a process 540 of measuring the location of the user terminal shown in FIG. 5; and

FIG. 8 is a block diagram illustrating an apparatus for measuring a location of a user terminal, using a magnetic field, according to exemplary embodiments of the disclosure.

### DETAILED DESCRIPTION OF THE ILLUSTRATED EMBODIMENTS

Exemplary embodiments of the disclosed subject matter are described more fully hereinafter with reference to the accompanying drawings. The disclosed subject matter may, however, be embodied in many different forms and should not be construed as limited to the exemplary embodiments set forth herein. Rather, the exemplary embodiments are provided so that this disclosure is thorough and complete, and will convey the scope of the disclosed subject matter to those skilled in the art. In the drawings, the size and relative sizes of layers and regions may be exaggerated for clarity. Like reference numerals in the drawings denote like elements.

It will be understood that when an element or layer is referred to as being “on”, “connected to”, or “coupled to” another element or layer, it can be directly on, connected, or coupled to the other element or layer or intervening elements or layers may be present. In contrast, when an element is referred to as being “directly on”, “directly connected to”, or “directly coupled to” another element or layer, there are no intervening elements or layers present. As used herein, the term “and/or” includes any and all combinations of one or more of the associated listed items. It may also be understood that for the purposes of this disclosure, “at least one of X, Y, and Z” can be construed as X only, Y only, Z only, or any combination of two or more items X, Y, and Z (e.g., XYZ, XYY, YZ, ZZ).

It will be understood that, although the terms first, second, third etc. may be used herein to describe various elements, components, regions, layers, and/or sections, these elements, components, regions, layers, and/or sections should not be limited by these terms. These terms are only used to distinguish one element, component, region, layer, or section from another region, layer or section. Thus, a first element, component, region, layer, or section discussed below could be termed a second element, component, region, layer, or section without departing from the teachings of the present disclosure.

The terminology used herein is for the purpose of describing exemplary embodiments only and is not intended to be limiting of the disclosed subject matter. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments of the disclosed subject matter are described herein with reference to cross-section illustrations that are schematic illustrations of idealized embodiments (and intermediate structures) of the disclosed subject matter. As such, variations from the shapes of the illustrations as a result, for example, of manufacturing techniques and/or tolerances, are to be expected. Thus, exemplary embodiments of the disclosed subject matter should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this disclosed subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the disclosed subject matter will be described in detail with reference to the accompanying drawings.

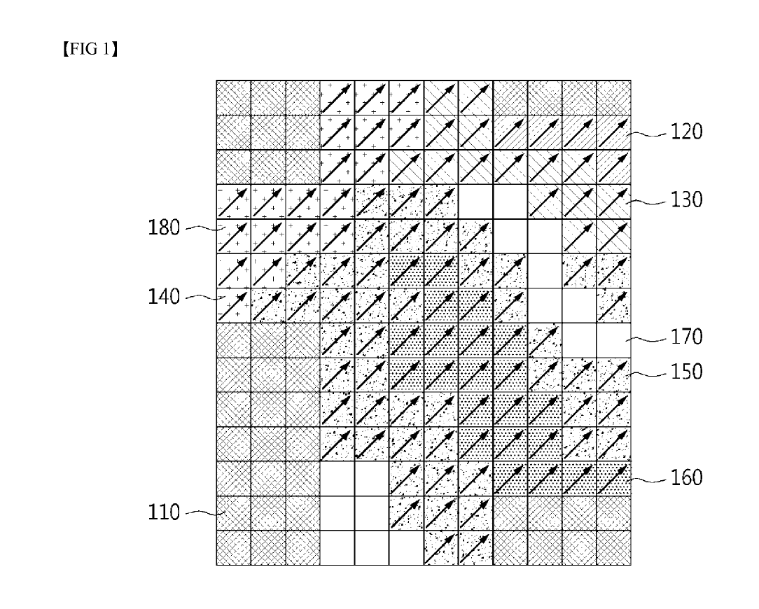

FIG. 1 is a diagram illustrating a map of a magnetic field according to exemplary embodiments of the disclosure.

Referring to FIG. 1, a map of a magnetic field according to exemplary embodiments of the disclosure is constructed based on horizontal components and vertical components of a magnetic field which are collected corresponding to preset coordinate information from one or more of a user terminal and a magnetic field measuring robot provided in the user terminal. The map of the magnetic field may be constructed based on map information including information on an internal or external structure of a building (hereinafter, structure information). For example, the map of the magnetic field may be constructed by horizontal components and vertical components of a magnetic field corresponding to preset coordinate information based on the information on the internal structure of the building. Specifically, the map of the magnetic field collects horizontal components and vertical components of the magnetic field corresponding to information on coordinates preset with respect to a specific reference point, respectively, referring to the structure information on walls and passages inside the building and it may be constructed according to the collected information.

Hereinafter, the map of the magnetic field is shown, considering only the horizontal components of the magnetic field. However, the map of the magnetic field may include more vertical components.

On the map of the magnetic field, a plurality of coordinates may be displayed as a plurality of cells and information on the magnetic field may be displayed on each of the cells. A cell 110 displaying information on coordinates (0, 1) indicates a wall inside the building and a cell 180 displaying information on coordinates (0, 10) may indicate a passage cell where the magnetic field is measured. More specifically, shade is displayed on the cell 110 indicating the wall inside the building and shade may be differently displayed on the passage cells where the magnetic field is measured based on intensities of the magnetic field. Arrows indicating directions of the magnetic field may be displayed on the cells having different shades based on the intensities of the magnetic field. At this time, a cell 120 indicates an intensity of a magnetic field corresponding to 0.4 Gauss or more and a cell 130 indicates an intensity of a magnetic field corresponding to 0.33˜0.44 Gauss. A cell 140 indicates an intensity of a magnetic field corresponding to 0.27˜0.33 Gauss and a cell 150 indicates an intensity of a magnetic field corresponding to 0.2˜0.27 Gauss. A cell 160 indicates an intensity of a magnetic field corresponding to 0.2 Gauss or less and a cell 170 indicates a low intensity of a magnetic field not detected from the magnetic field sensor.

As mentioned above, the map of the magnetic field shows the information on the magnetic field corresponding to the information on the preset coordinates and the information on the magnetic field corresponding to the information on the preset coordinates as the cells. Alternatively, the map of the magnetic fields shows them as contour lines or values.

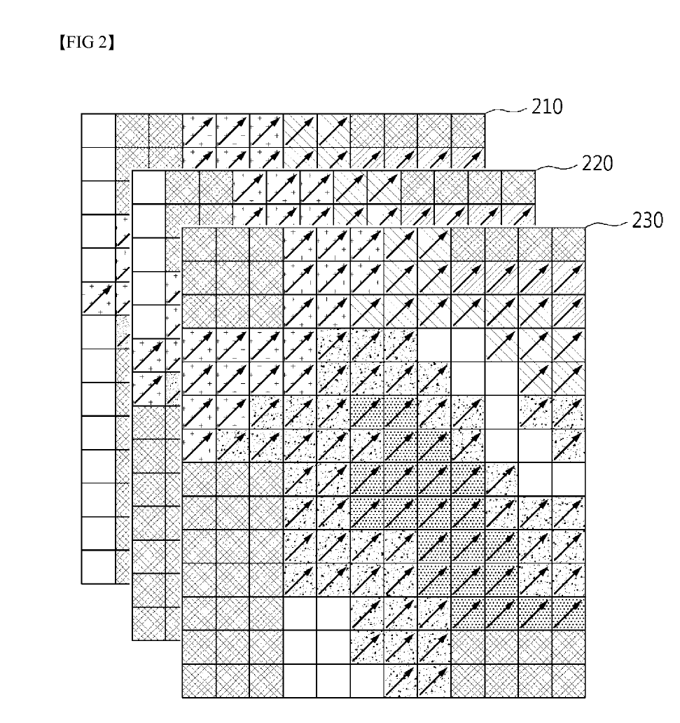

FIG. 2 is a diagram illustrating a map of a magnetic field based on a height.

Referring to FIG. 2, the map of the magnetic field according to the embodiments of the disclosure may be generated at each preset height. Here, the preset heights may be set as specific heights at which horizontal and vertical components of the magnetic field are changed at coordinates which are horizontally the same. For example, For example, when heights where a horizontal value and a vertical value of a magnetic field at coordinates horizontally identical are changed are 2 m and 4 m from the ground, the map of the magnetic field may include a first map of the magnetic field 210 for a height of 0˜2 m, a second map of the magnetic field 220 for a height of 4˜6 m and a third map of the magnetic field 230 at a height of 4˜6 m. Each map of the magnetic field may display a horizontal value and a vertical value of the magnetic field corresponding to coordinate information preset at each of the preset heights. More specifically, the first map of the magnetic field 210 may be a map of a magnetic field corresponding to a first floor in the building and the second map of the magnetic field 220 may be map of a magnetic field corresponding to a second floor in the building. The third map of the magnetic field 230 may be map of a magnetic field corresponding to a third floor in the building.

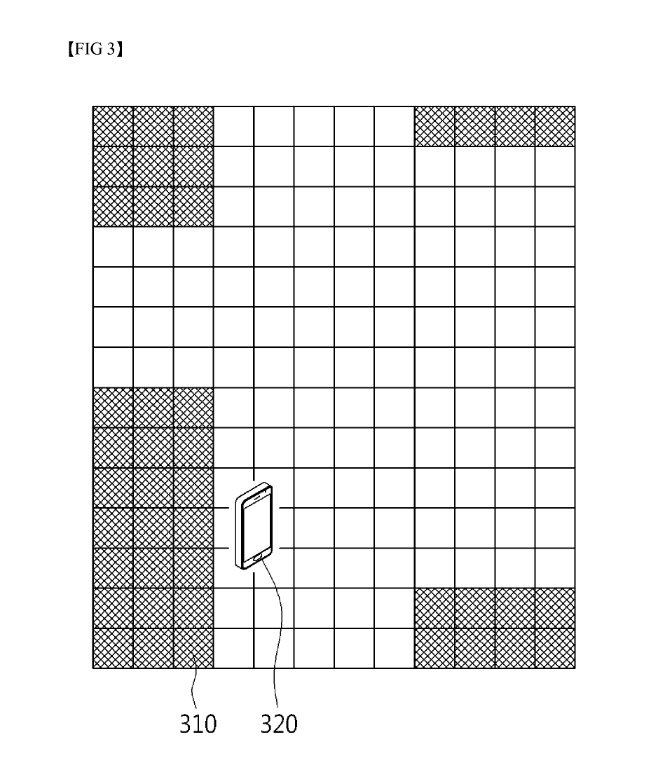

FIG. 3 is a diagram illustrating a process of measuring a location of a user terminal according to exemplary embodiments of the disclosure.

Referring to FIG. 3, a wall 310 and a user terminal 320 are displayed on the map for the internal structure of the building as structure information.

An apparatus for measuring a location of a user terminal, using a magnetic field, according to exemplary embodiments of the disclosure may receive constructed information on a map of a magnetic field inside the building in advance. Hence the apparatus for measuring the location of the user terminal may acquire a first measured value from a magnetic field sensor provided in a user terminal and a second measured value from another sensor distinguished from the magnetic field sensor, such that it may measure the location of the user terminal 320 based on the received information on the map of the magnetic field, the first measured value and the second measured value. The information on the map of the magnetic field includes horizontal components and vertical components of the magnetic field corresponding to information on preset coordinates. The first measured value includes a horizontal value and a vertical value of the magnetic field acquired from the user terminal 320. Accordingly, a horizontal location and a vertical location of the user terminal are mapped with a horizontal value of the horizontal components and a vertical value of the vertical components provided in the information on the map of the magnetic field. For example, when the information on the map of the magnetic field includes information on a magnetic field (0.2, 0.33 and 0.54) corresponding to information on coordinates (4, 4) on the right of the wall 310, with a magnetic field (0.2, 0.33 and 0.54) measured in the user terminal 320, it is shown that the user terminal 320 is located in coordinates (4, 4) on the right of the wall 310. At this time, the magnetic field may be displayed with horizontal components having x-components and y-components and vertical components having z-components.

The apparatus for measuring the location of the user terminal, using the magnetic field, may uses the second measured value in measuring the location of the user terminal 320 accurately based on the result of comparison between the first measured value and the information on the map of the magnetic field. For example, there is little difference between a magnetic field (0.2, 0.33 and 0.53) corresponding to coordinates (2. 8) on an upper portion of the wall 310 and a magnetic field (0.2, 0.33 and 0.54) corresponding to coordinates (4, 4) on the right of the wall 310. Accordingly, it is difficult to measure whether the user terminal 320 is located on the right of the wall 310 or the upper portion of the wall 310. The horizontal location and the vertical location of the user terminal 320 may be corrected by another sensor distinguished from the magnetic field sensor provided in the user terminal 320. At this time, one or more of an acceleration sensor, an inertia sensor, a gyro sensor, a pressure sensor, a ultrasonic sensor, a temperature-humidity sensor, an infrared sensor, a Ultra-Wide Band sensor and a sensor for detecting Wi-Fi LAN or LED may be used as the distinguished sensor. For example, the apparatus for measuring the location of the user terminal, using the map of the magnetic field, acquires one or more of the user's stride, moving direction, moving distance and moving speed based on the value acquired by the sensor distinguished from the magnetic field sensor based on the second measured value acquired from another sensor distinguished from the magnetic field sensor. Then, the apparatus for measuring the location of the user terminal may correct a horizontal location or a vertical location of the user terminal 320 measured, using one or more of the acquired stride, moving direction, moving distance and moving speed. At this time, the user's stride, moving direction, moving distance or moving speed may be provided in Pedestrian Dead-Reckoning information.

An apparatus for measuring a location of a user terminal, using a magnetic field, according to another embodiment of the disclosure receives an initial location of the user terminal 320 from the user terminal 320 and sets candidate locations of the user terminal based on the initial location. After that, the apparatus for measuring the location of the user terminal, using the map of the magnetic field may select a location of the user terminal 320 from the set candidate locations, based on the map of the magnetic field and a first measured value and a second measured value. For example, when an initial location is input from the user terminal 320 is on the right of a wall 310, the apparatus for measuring the location of the user terminal, using the map of the magnetic field may set candidate locations of the user terminal 320 from the initial location on the right of the wall 310 based on one or more of the user's stride, moving direction, moving distance and moving speed provided from the user terminal 320. Also, the system may select the location of the user terminal 320, using the map of the magnetic field and values of the magnetic field measured by the magnetic field.

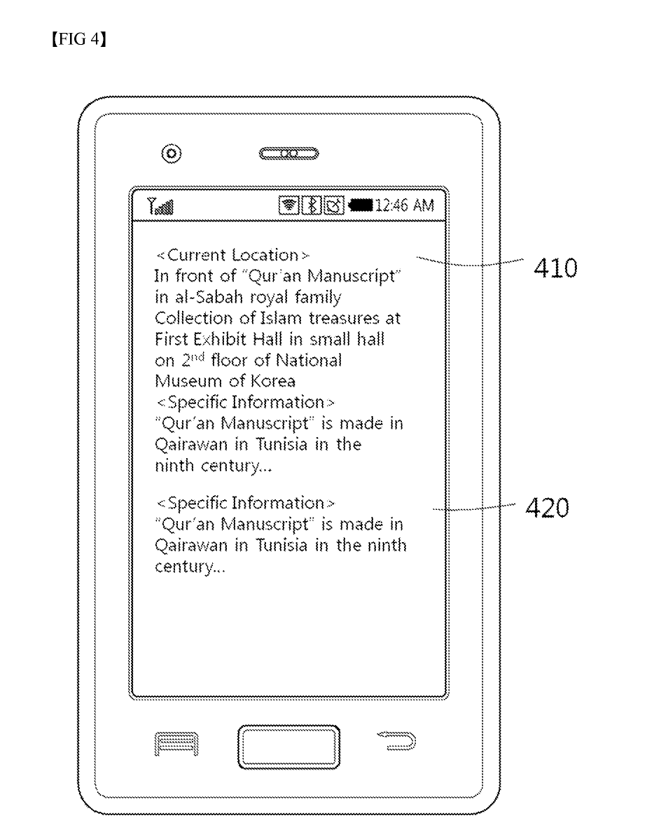

FIG. 4 is a diagram illustrating a specific service associated with a location of a user terminal according to exemplary embodiments of the disclosure.

Referring to FIG. 4, the apparatus for measuring the location of the user terminal, using the magnetic field, according to the exemplary embodiments of the disclosure may provide a current location 410 of the user terminal and a specific service 420 associated with a location of the user terminal based on the location of the user terminal. For example, when the user terminal is positioned on the right of the wall shown in FIG. 3, with Qur'an manuscript exhibited on the wall to the right which is one of Islamic treasures, a current location 410 of the user terminal and specific information displaying service 420 displaying specific information on “Qur'an manuscript” may be provided.

Also, the specific service may be provided in response to change in locations of the user terminal adaptively. For example, when the user terminal is moving along an upper portion of the wall from a right portion of the wall, with a port ornament exhibited on an upper portion of the wall, a changed location of the user terminal and a specific information displaying service for “port ornament” may be provided as specific information.

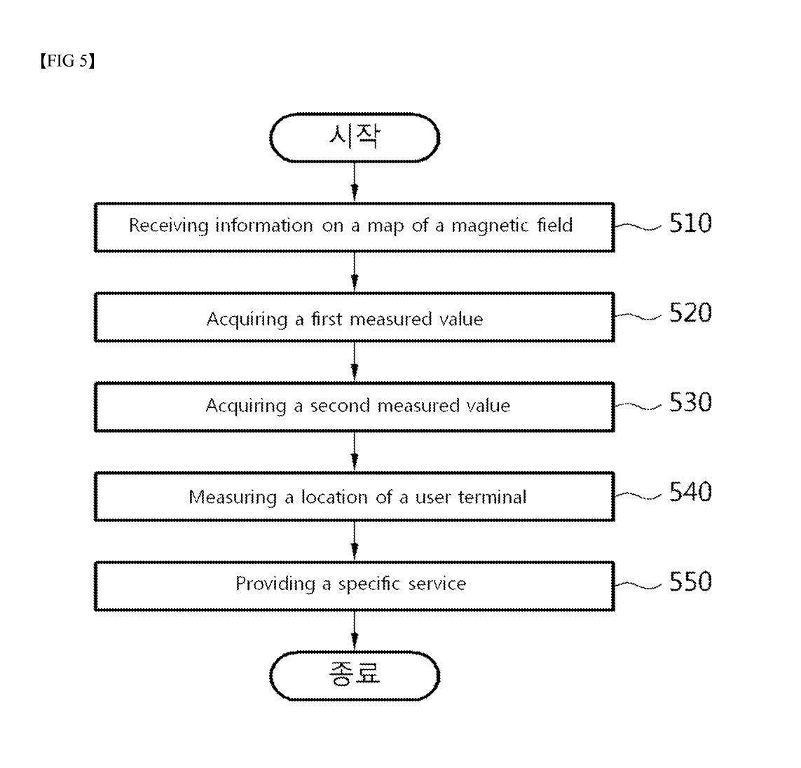

FIG. 5 is a flow chart illustrating a method for constructing a map of a magnetic field according to exemplary embodiments of the closure.

Referring to FIG. 5, the apparatus for measuring the location of the user terminal, using the magnetic field receives the information on the map of the magnetic field (510). The map of the magnetic field according to exemplary embodiments of the disclosure is constructed based on horizontal components and vertical components of the magnetic field which are collected corresponding to preset coordinate information from one or more of a user terminal and a magnetic field measuring robot provided in the user terminal.

The apparatus for measuring the location of the user terminal, using the magnetic field, acquires a first measured value from the magnetic field sensor provided in the user terminal (520).

The apparatus for measuring the location of the user terminal, using the magnetic field, acquires a second measured value from another sensor distinguished from the magnetic field sensor provided in the user terminal (530). At this time, One or more of an acceleration sensor, an inertia sensor, a gyro sensor, a pressure sensor, a ultrasonic sensor, a temperature-humidity sensor, an infrared sensor, a Ultra-Wide Band sensor and a sensor for detecting Wi-Fi LAN or LED may be used as the distinguished sensor.

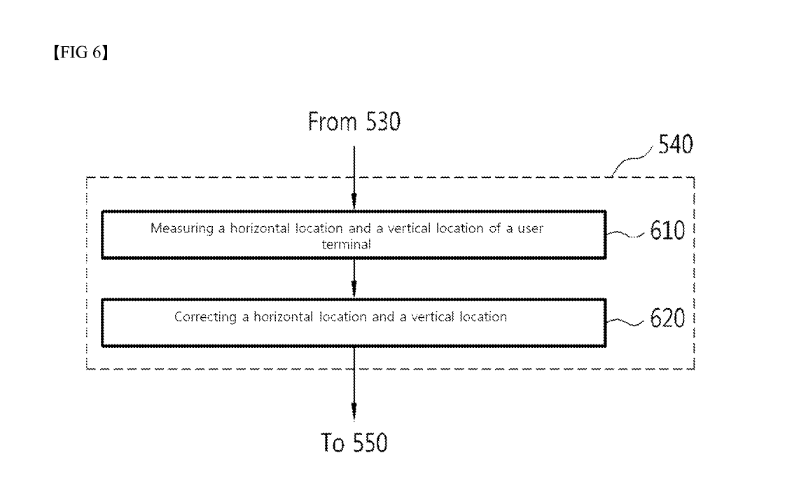

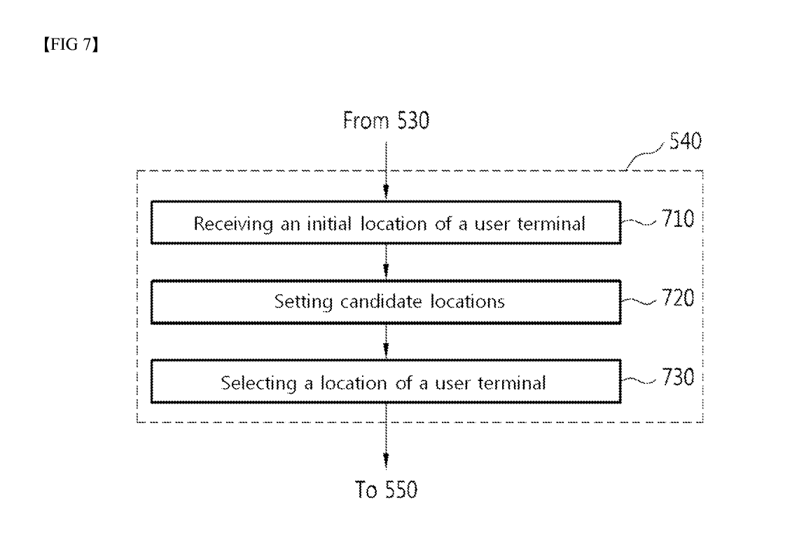

The apparatus for measuring the location of the user terminal, using the magnetic field, may measures the location of the user terminal based on the information on the magnetic field, the first measured value and the third measured value (540). A first embodiment will be described, referring to FIG. 6 and a second embodiment will be described, referring to FIG. 7.

The apparatus for measuring the location of the user terminal, using the magnetic field, may provide a specific service associated with the location of the user terminal based on the location of the user terminal (550).

FIG. 6 is a first flow chart specifically illustrating the process of measuring the location of the user terminal shown in FIG. 5.

Referring to FIG. 6, the process of measuring the location of the user terminal (540) may be performed according to a first embodiment as follows.

According to the first embodiment of the disclosure, the apparatus for measuring the location of the user terminal, using the magnetic field may match a horizontal value and a vertical value provided in the first measured value with a horizontal component and a vertical component provided in the information on the map of the magnetic field, respectively, and measure a horizontal location and a vertical location of the user terminal based on the result of the matching (610).

The apparatus for measuring the location of the user terminal may correct a horizontal location and a vertical location, using the second measured value (620). At this time, the process of correcting the horizontal location and the vertical location, using the second measured value, may include a step of acquiring one or more of the terminal user's stride, the moving direction of the user terminal, the moving distance of the user terminal and the moving speed of the user terminal based on the second measured value; and a step of correcting the horizontal location and the vertical location, using one or more of the user's stride, the moving direction of the user terminal, the moving distance of the user terminal and the moving speed of the user terminal.

Alternatively, the process of measuring the location of the user terminal (540) may be performed according to the second embodiment which will be described in detail, referring to FIG. 7.

FIG. 7 is a second flow chart specifically illustrating the process of measuring the location of the user terminal shown in FIG. 5.

Referring to FIG. 7, the process of measuring the location of the user terminal (540) may be performed according to a second embodiment as follows.

According to the second embodiment, the apparatus for measuring the location of the user terminal, using the magnetic field may receive an initial location of the user terminal from the user terminal (710).

The apparatus for measuring the location of the user terminal, using the magnetic field, may set candidate locations of the user terminal based on the provided initial locations (720).

The apparatus for measuring the location of the user terminal, using the magnetic field, may select a location of the user terminal from the candidate locations based on the information on the map of the magnetic field, the first measured value and the second measured value (730).

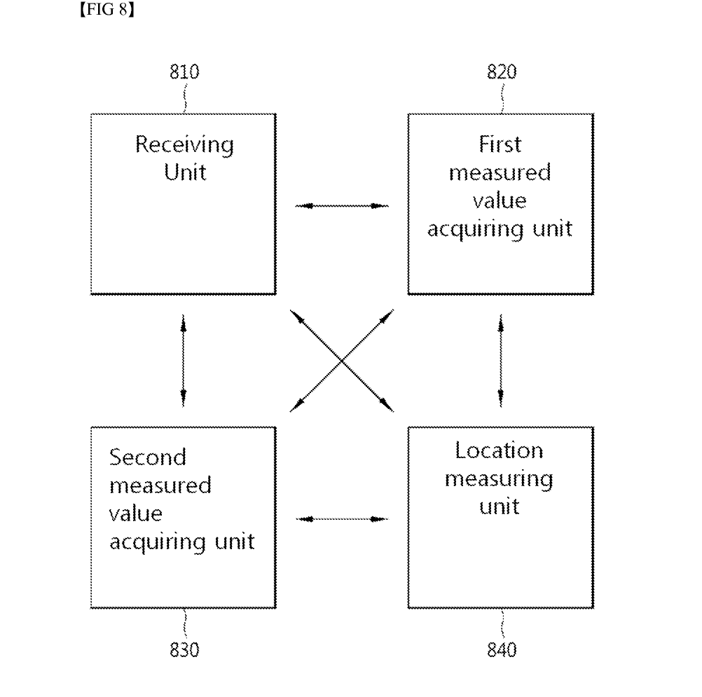

FIG. 8 is a block diagram illustrating the apparatus for measuring the location of the user terminal according to the exemplary embodiment of the disclosure.

Referring to FIG. 8, the apparatus for measuring the location of the user terminal, using the magnetic field, includes a receiving unit 810, a first measured value acquiring unit 820, a second measured value acquiring unit 830 and a location measuring unit 840.

The receiving unit 810 receives the information on the map of the magnetic field.

The first measured value acquiring unit 820 acquires the first measured value from the magnetic field sensor provided in the user terminal.

The second measured value acquiring unit 830 acquires the second measured value from another senor provided in the user terminal and distinguished from the magnetic sensor.

At this time, the location measuring unit 840 measures the location of the user terminal based on the information on the map of the magnetic field, the first measured value and the second measured value.

The location measuring unit 840 matches a horizontal value and a vertical value provided in the first measured value with a horizontal component and a vertical component provided in the information on the map of the magnetic field, respectively, and measures the horizontal location and the vertical location of the user terminal based on the result of the matching. Also, the location measuring unit 840 may correct a horizontal location and a vertical location of the user terminal, using the second measured value.

Moreover, the location measuring unit 840 may receive an initial location of the user terminal from the user terminal and set candidate locations of the user terminal based on the initial location. After that, the apparatus for measuring the location of the user terminal, using the map of the magnetic field may select a location of the user terminal from the set candidate locations, based on the map of the magnetic field and a first measured value and a second measured value.

It will be apparent to those skilled in the art that various modifications and variations can be made in the present disclosure without departing from the spirit or scope of the disclosed subject matter.

Thus, it is intended that the present disclosure cover the modifications and variations of the disclosed subject matter provided they come within the scope of the appended claims and their equivalents.

What is claimed is:

1. A method for measuring a location of a user terminal, using a magnetic field comprising:
receiving information on a map of the magnetic field;
acquiring a first measured value from a magnetic field sensor provided in the user terminal;
acquiring a second measured value from another sensor provided in the user terminal and distinguished from the magnetic field sensor; and
measuring a location of the user terminal based on the information on the map of the magnetic field, the first measured value and the second measured value.

2. The method of measuring the location of the user terminal, using the magnetic field, according to claim 1, wherein the sensor distinguished from the magnetic field sensor comprises one or more of an acceleration sensor, an inertia sensor, a gyro sensor, a pressure sensor, a ultrasonic sensor, a temperature-humidity sensor, an infrared sensor, a UWB (Ultra-Wideband) sensor, Wi-Fi (Wireless Fidelity) sensor or a LED (Light Emitting Diode) sensor.

3. The method of measuring the location of the user terminal, using the magnetic field, according to claim 1, wherein the information on the map of the magnetic field sensor is set based on horizontal components and vertical components of a magnetic field which are collected corresponding to preset coordinate information from one or more of the user terminal and a magnetic field measuring robot provided in the user terminal.

4. The method of measuring the location of the user terminal, using the magnetic field, according to claim 3, wherein the step of measuring the location of the user terminal comprises,
measuring a horizontal location and a vertical location of the user terminal based on the result of the matching a horizontal value and a vertical value provided in the first measured value with a horizontal component and a vertical component provided in the information on the map of the magnetic field, respectively; and
correcting a horizontal location and a vertical location, using the second measured value.

5. The method of measuring the location of the user terminal, using the magnetic field, according to claim 5, wherein the measuring the location of the user terminal comprises,
acquiring one or more of a terminal user's stride, a moving direction of the user terminal, a moving distance of the user terminal and a moving speed of the user terminal based on the second measured value; and
correcting the horizontal location and the vertical location, using one or more of the user's stride, the moving direction of the user terminal, the moving distance of the user terminal and the moving speed of the user terminal.

6. The method of measuring the location of the user terminal, using the magnetic field, according to claim 1, wherein the measuring the location of the user terminal further comprises,
receiving an initial location of the user terminal from the user terminal;
setting candidate locations of the user terminal based on the provided initial locations; and
selecting a location of the user terminal from the candidate locations based on the information on the map of the magnetic field, the first measured value and the second measured value.

7. The method of measuring the location of the user terminal, using the magnetic field, according to claim 1, further comprising:
providing a specific service associated with the location of the user terminal based on the location of the user terminal.

8. An apparatus for measuring a location of a user terminal, using a magnetic field, comprising:
a receiving unit for receiving information on a map of a magnetic field;
a first measured value acquiring unit for acquiring a first measured value from a magnetic field sensor provided in the user terminal;
a second measured value acquiring unit for acquiring a second measured value from another senor provided in the user terminal and distinguished from the magnetic sensor; and
a location measuring unit for measuring the location of the user terminal based on the information on the map of the magnetic field, the first measured value and the second measured value.

9. The apparatus for measuring the location of the user terminal according to claim 8, wherein the location measuring unit matches a horizontal value and a vertical value provided in the first measured value with a horizontal component and a vertical component provided in the information on the map of the magnetic field, respectively, and measures a horizontal location and a vertical location of the user terminal based on the result of the matching, and
the location measuring unit corrects the horizontal location and the vertical location of the user terminal, using the second measured value.
